(19) United States
(12) Patent Application Publication
(10) Pub. No.: US 2019/0349569 A1
(43) Pub. Date: Nov. 14, 2019

(54) HIGH-SENSITIVITY LOW-POWER CAMERA SYSTEM FOR 3D STRUCTURED LIGHT APPLICATION

(71) Applicant: Samsung Electronics Co., Ltd., Suwon-si (KR)

(72) Inventors: Yibing Michelle WANG, Pasadena, CA (US); Seunghoon HAN, Seoul (KR); Lilong SHI, Pasadena, CA (US); Byunghoon NA, Hwasung-si (KR); Ilia OVSIANNIKOV, Studio City, CA (US)

(21) Appl. No.: 16/038,146

(22) Filed: Jul. 17, 2018

Related U.S. Application Data
(60) Provisional application No. 62/669,931, filed on May 10, 2018.

(51) Int. Cl. H04N 13/254; H04N 13/271; H04N 13/207; H04N 13/296

(52) U.S. Cl. CPC H04N 13/254; H04N 13/296; H04N 13/207; H04N 13/271

(57) ABSTRACT

A structured-light imaging system includes a projector, an image sensor and a controller. The projector projects a structured-light pattern onto a selected slice of a scene in which the selected slice of the scene includes a first predetermined size in a first direction and a second predetermined size in a second direction that is substantially orthogonal to the first direction. The image sensor scans the selected slice of the scene and generates an output corresponding to each region of at least one region of the selected slice. The image sensor and the projector are synchronized in an epipolar manner. The controller is coupled to the image sensor and detects whether an object is located within each scanned region and controls the projector to project the structured-light pattern a first plurality of times towards regions of the selected slice of the scene in which no object has been detected.

### CROSS-REFERENCE TO RELATED APPLICATION

This patent application claims the priority benefit under 35 U.S.C. § 119(e) of U.S. Provisional Patent Application No. 62/669,931, filed on May 10, 2018, the disclosure of which is incorporated herein by reference in its entirety.

### TECHNICAL FIELD

The subject matter disclosed herein generally relates to a system and a method for a structured-light system and, more particularly, a system and a method for a low-power structured-light system having high sensitivity.

### BACKGROUND

Under high ambient-light conditions, a three-dimensional (3D) structured light camera needs a high dynamic range in order to detect objects that are less than about four meters while also being able to detect objects that are much farther away. The high ambient-light conditions may saturate pixels of a sensor of the camera for short-range objects, while also significantly reducing signal-to-noise ratio (SNR) for longer-range objects.

### SUMMARY

An example embodiment provides a structured-light imaging system that may include a projector, an image sensor and a controller. The projector may project a structured-light pattern onto a selected slice of a scene comprising one or more objects in which the selected slice of the scene may include a first predetermined size in a first direction and a second predetermined size in a second direction that is substantially orthogonal to the first direction. The image sensor may scan the selected slice of the scene and may generate an output corresponding to a region of the selected slice in which the image sensor and the projector may be synchronized in an epipolar manner. The controller may be coupled to the image sensor and may detect whether an object is located within the scanned region and may control the projector to project the structured-light pattern a first plurality of times away from the scanned region towards other regions of the selected slice of the scene if an object has been detected in the scanned region. In one embodiment, the controller may further determine a reflectivity of a detected object based on an intensity difference between black pixels and white pixels in the scanned region. In another embodiment, the first predetermined size of the selected slice in the first direction may be greater than the second predetermined size of the selected slice in the second direction, the controller may further control the projector to project the structured-light pattern toward a first predetermined number of slices in a selected order, the image sensor may scan the first predetermined number of slices in the selected order, and the selected order may be a random order.

Another example embodiment provides a structured-light imaging system that may include a projector, an image sensor and a controller. The projector may project a structured-light pattern onto a selected slice of a scene comprising one or more objects in which the selected slice of the scene may include a first predetermined size in a first direction and a second predetermined size in a second direction that is substantially orthogonal to the first direction and in which the first predetermined size of the selected slice in the first direction may be greater than the second predetermined size of the selected slice in the second direction. The image sensor may scan the selected slice of the scene and may generate an output corresponding to a region of the selected slice in which the image sensor and the projector may be synchronized in an epipolar manner. The controller may be coupled to the image sensor and may detect whether an object is located within the scanned region and may control the projector to project the structured-light pattern a first plurality of times away from the scanned region towards other regions of the selected slice of the scene if an object has been detected in the scanned region. In one embodiment, the controller may further control the projector to project the structured-light pattern toward a first predetermined number of slices in a selected order, the image sensor may scans the first predetermined number of slices in the selected order, and the selected order may be a random order.

Still another example embodiment provides a method for a structured-light imaging system to scan a scene that may include: projecting from a projector a structured-light pattern onto a selected slice of a scene comprising one or more objects, the selected slice of the scene comprising a first predetermined size in a first direction and a second predetermined size in a second direction that is substantially orthogonal to the first direction; scanning the selected slice of the scene using an image sensor, the image sensor and the projector being synchronized in an epipolar manner; generating an output corresponding to a region of the selected slice; detecting whether an object is located within the scanned region; and controlling the projector using a controller to project the structured-light pattern a first plurality of times away from the scanned region towards other regions of the selected slice of the scene if an object has been detected in the scanned region. In one embodiment, the structured-light pattern may include a row of a plurality of sub-patterns extending in the first direction in which each sub-pattern may be adjacent to at least one other sub-pattern, each sub-pattern may be different from each other sub-pattern, each sub-pattern may include a first predetermined number of regions in a sub-row and second predetermined number of regions in a sub-column in which the first predetermined number and the second predetermined number may be an integer, each region may be substantially a same size, each sub-row may extend in the first direction and each sub-column may extend in a second direction that is substantially orthogonal to the first direction. In one embodiment, the image sensor may include a plurality of global shutter arrays in which a global shutter array corresponds to an epipolar scan line, and in which the image sensor may further operate in one of a random shutter mode and a rolling shutter mode. In one embodiment, the projector may project the structured-light pattern the first plurality of times away from the scanned region to detect an object that is farther away than the object detected in the scanned region. In yet another embodiment, the method may further include determining at the controller a reflectivity of the object detected in the scanned region based on an intensity difference between black pixels and white pixels in the scanned region.

### BRIEF DESCRIPTION OF THE DRAWINGS

In the following section, the aspects of the subject matter disclosed herein will be described with reference to exemplary embodiments illustrated in the figures, in which:

FIG. 1 depicts a block diagram of an example embodiment of a structured-light imaging system according to the subject matter disclosed herein;

FIG. 1A depicts an example embodiment of a typical reference light pattern;

FIG. 1B depicts an example embodiment of a base light pattern;

FIG. 2 depicts an example of how an epipolar scan, or a point scan, may be performed for 3D-depth measurements according to one embodiment disclosed herein;

FIG. 3A is a scene of an illuminated mirrored disco ball that has been imaged by a camera using a non-epipolar-imaging technique;

FIG. 3B is the same scene of the illuminated mirror disco ball that has been imaged using an epipolar-imaging technique;

FIG. 4 depicts an example reference light pattern that has been divided into slices that may be projected on to a scene slice-by-slice according to the subject matter disclosed herein;

FIG. 5 depicts an example flow diagram of a method of using a structured-light camera system to selectively project/scan a scene in a slice-by-slice manner according to the subject matter disclosed herein;

FIG. 6A depicts an example stacked architecture that may be used for a sensor in a camera according to the subject matter disclosed herein;

FIG. 6B depicts an example embodiment of pixels of a pixel array according to the subject matter disclosed herein; and

FIG. 7 depicts an example portion of an output of a detected slice of a scene according to the subject matter disclosed herein.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail not to obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not be necessarily all referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. Similarly, various waveforms and timing diagrams are shown for illustrative purpose only. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing particular exemplary embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement the teachings of particular embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments disclosed herein provide a structured-light 3D system that may be used outdoors for mid-range applications, and may be suitable for use on, for example, smartphones, drones, and altered reality/virtual reality (AR/VR) devices.

One embodiment disclosed herein provides a structured-light imaging system that may include a projector/scanner that may be controlled to selectively project/scan a scene in a slice-by-slice manner. In one embodiment, the selected order that projector/scanner may be controlled may be a random order. The projector/scanner may use pulses that have a relatively high peak optical power and a relatively short pulse duration. The image sensor may be synchronized with the projector/scanner to capture images using subpixel arrays having a global shutter arrangement that correspond to epipolar planes of the projector, thereby rejecting multipath reflections that may cause depth errors, thereby avoiding saturating the optical sensor while also providing a high SNR. A scanning repetition of each slice may be determined based on a detected distance and a detected reflectance of objects within the slice. Alternatively, a scanning repetition of each epipolar plane may be determined based on a detected distance and a detected reflectance of objects within the epipolar plane. The projected light may be redirected towards other parts of the slice or plane after an object on the same slice or plane has been detected. Accordingly, the optical power needed for mid-range 3D detection may be two orders of magnitude less than a traditional method that uses a typical CMOS image sensor (CIS).

In one embodiment, the image sensor may be an image sensor having a high-conversion gain and a fast readout, and may be used together with a light projector/scanner providing an epipolar-plane imaging technique to overcome high ambient-light conditions. A typical CIS may not have a high enough conversion gain to detect every photoelectron that may be reflected off object at close range and at longer distances. A typical CIS that may have a small pixel pitch for 2D imaging usually includes a full well that does not have a sufficiently high dynamic range for detecting objects at all ranges, whereas a typical CIS having a large pixel pitch and a global shutter does not have a large enough spatial resolution to have fine enough disparity resolution for 3D imaging. In alternative embodiment, the image sensor for a system disclosed herein may be a special CIS having a very small pixel pitch, a high sensitivity, a low full well capacity, and a fast readout time.

Another embodiment disclosed herein relates to a method of generating depth map information using less optical power than typical techniques. A projector having a high peak optical power with short duration pulses may be used to project a structured-light pattern. A sensor having a global shutter and a short integration time for each subarray of the sensor may be controlled in an epipolar synchronism with the projector to significantly suppress strong ambient-light conditions, and to reduce the average optical power used by the projector. Objects that are close to a camera may have a greater depth resolution due to a finer disparity that is available from a small pixel pitch of the image sensor. If an object that is close to the image sensor is detected, projected light is redirected to other areas of a scene in order to detect any objects that are farther away. The reflectivity of an object may also be determined based on the light that has been reflected from an object minus the ambient light.

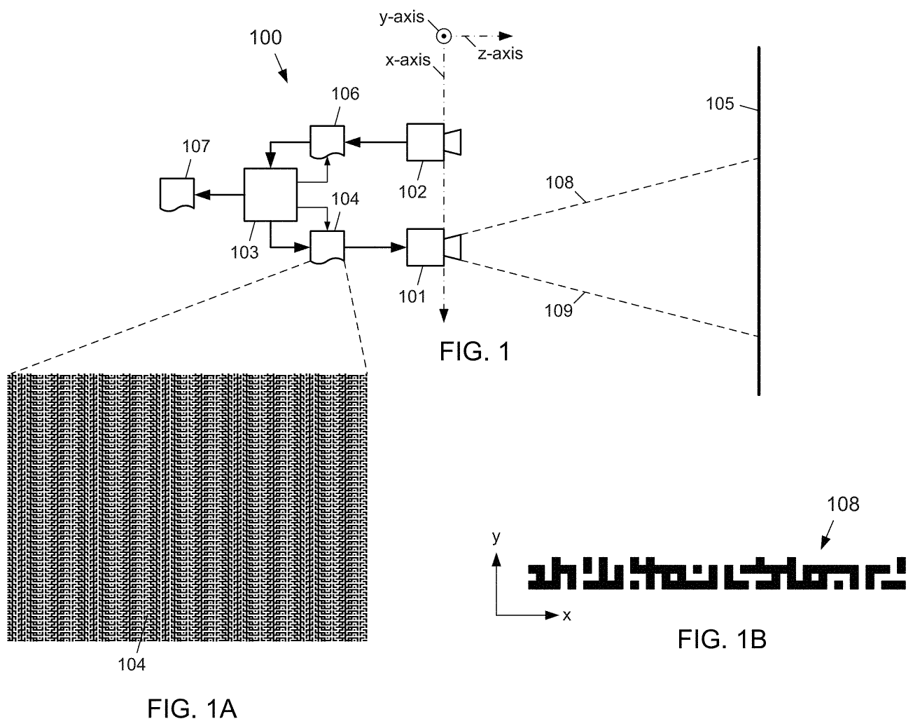

FIG. 1 depicts a block diagram of an example embodiment of a structured-light imaging system 100 according to the subject matter disclosed herein. The structured-light imaging system 100 may include a projector 101, a camera 102 and a controller, or processing, device 103. In operation, the controller 103 sends a reference light pattern 104 to the projector 101, and the projector 101 projects the reference light pattern 104 onto a scene that is represented by a line 105 in FIG. 1. The camera 102 captures the scene having the projected reference light pattern 104 as an image 106. The image 106 is transmitted to the controller 103, and the controller 103 generates a depth map 107 based on a disparity of the reference light pattern as captured in the image 106 with respect to the reference light pattern 104. The depth map 107 includes estimated depth information corresponding to patches of the image 106.

In one embodiment, the controller 103 may control the projector 101 and the camera 102 to be synchronized in an epipolar manner. Additionally, the projector 101 and the camera 102 may form a metaphotonics projector/scanner system that may be used to illuminate the scene 105 using high peak power, short duration light pulses line-by-line in an epipolar manner.

The controller 103 may be a microprocessor or a personal computer programmed via software instructions, a dedicated integrated circuit or a combination of both. In one embodiment, the processing provided by controller 103 may be implemented completely via software, via software accelerated by a graphics processing unit (GPU), a multicore system or by a dedicated hardware, which is able to implement the processing operations. Both hardware and software configurations may provide different stages of parallelism. One implementation of the structured-light imaging system 100 may be part of a handheld device, such as, but not limited to, a smartphone, a cellphone or a digital camera.

In one embodiment, the projector 101 and the camera 102 may be matched in the visible region or in the infrared light spectrum, which may not visible to human eyes. The projected reference-light pattern may be within the spectrum range of both the projector 101 and the camera 102. Additionally, the resolutions of the projector 101 and the camera 102 may be different. For example, the projector 101 may project the reference light pattern 104 in a video graphics array (VGA) resolution (e.g., 640×480 pixels), and the camera 102 may have a resolution that is higher (e.g., 1280×720 pixels). In such a configuration, the image 106 may be down-sampled and/or only the area illuminated by the projector 101 may be analyzed in order to generate the depth map 107.

FIG. 1A depicts an example embodiment of a typical reference light pattern 104. In one embodiment, the typical reference light pattern 104 may include a plurality of reference light-pattern elements that may be repeated in both horizontal and vertical direction to completely fill the reference light pattern 104. FIG. 1B depicts an example embodiment of a base light pattern 108 that is 48 dots wide in a horizontal direction (i.e., the x direction in FIG. 1B), and four dots high in a vertical direction (i.e., the y direction in FIG. 1B). Other base light patterns are possible. For simplicity, the ratio of dots to pixels may be 1:1, that is, each projected dot may be captured by exactly one pixel in a camera, such as camera 102. In one embodiment, the typical reference light pattern 104 of FIG. 1A may be formed by repeating the base light pattern 108 ten times in the horizontal direction and 160 times in the vertical direction.

If, for example, a 4×4 pixel window is superimposed on the base light pattern 108 and slid horizontally (with wrapping at the edges), there will be 48 unique sub-patterns. If the 4×4 pixel window is slid vertically over the four pixels of the height of the base light pattern 108 (with wrapping) as the 4×4 pixel window is also slid horizontally, there will be a total of 192 unique sub-patterns.

Referring back to FIG. 1, the x-axis is taken to be the horizontal direction along the front of the structured-light imaging system 100, the y-axis is the vertical direction (out of the page in this view), and the z-axis extends away from the imaging system 100 in the general direction of the scene 105 being imaged. For depth measurements, the optical axes of the projector 101 and the camera 102 may be parallel to the z-axis. Other optical arrangements may be used as well to implement the principles described herein and are considered to be within the scope of the subject matter disclosed herein.

In one embodiment, the projector 101 may include a light source, such as, but not limited to a diode laser, a Light Emitting Diode (LED) emitting visible light, a near infrared (NIR) laser, a point light source, a monochromatic illumination source (such as, a combination of a white lamp and a monochromator) in the visible light spectrum, or any other type of laser light source. In one embodiment, a laser light source may be fixed in one position within a housing of the imaging system 100, and may be rotatable in the x and y directions. Additionally, the projector 101 may include projection optics, such as, but not limited to a focusing lens, a glass/plastics surface, and/or other cylindrical optical element that may concentrate a laser beam from the laser light source as a point or spot on that surface of objects in the scene 105.

The camera 102 may include optics that may focus a light spot on an object in the scene 105 as a light spot on an image sensor that may include a pixel array. The camera 102 may also include a focusing lens, a glass/plastics surface, or other cylindrical optical element that concentrates the reflected light received from an object in the scene 10 onto one or more pixels in a two-dimensional (2D) array. The 2D array of pixels may form an image plane in which each respective row of pixels forms an epipolar line of a scanning line on the scene 105. In one embodiment, the image sensor of the camera 102 may be an image sensor having a high-conversion gain and a fast readout, and may be used as part of a light projector/scanner providing an epipolar-plane imaging technique to overcome high ambient-light conditions. In one embodiment, each pixel of the image sensor may include a photodiode that may have a full well capacity of less than about 200e−, and may have a conversion gain that may be greater than about 500 kV/e−. The image sensor may also include a small pixel pitch of about 1 μm.

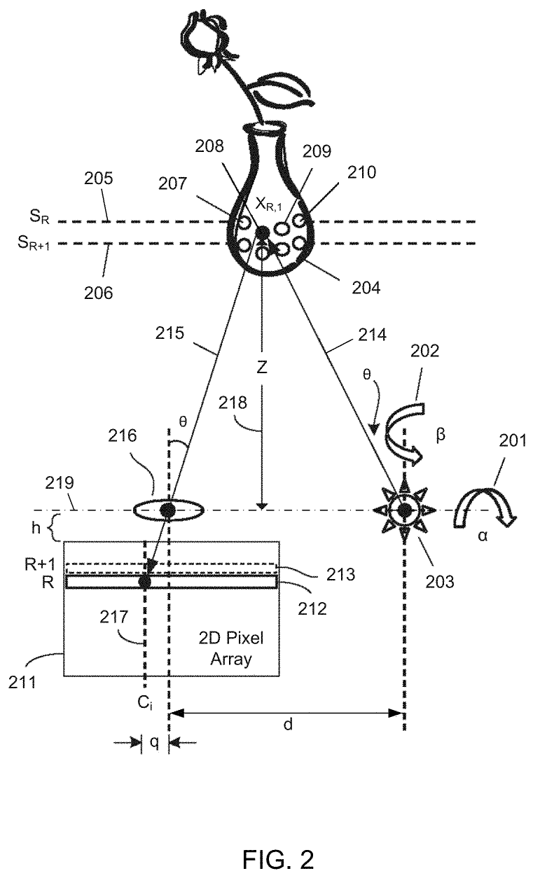

The projector 101 may illuminate the scene, as indicated by dotted lines 108 and 109, using a point-scan, or epipolar-scan, technique. That is, a light beam from a laser light source may be point scanned under the control of the processing device 103 in the x-y direction across the scene 105. The point-scan technique may project light spots on the surface of any objects in the scene 105 along a scan line, as discussed in more detail with reference to FIG. 2. The light reflected from the point scan of the scene 105 may include photons reflected from or scattered by surfaces of objects in the scene 105 upon receiving illumination from a laser source of the projector 101. The light received from an illuminated object may be focused onto one or more pixels of, for example, the 2D pixel array via the collection optics in the camera 102. The pixel array of the camera may convert the received photons into corresponding electrical signals, which are then processed by the controller 103 a 3D-depth image of the scene 105. In one embodiment, the controller 103 may use a triangulation technique for depth measurements.

FIG. 2 depicts an example of how an epipolar scan, or a point scan, may be performed for 3D-depth measurements according to one embodiment disclosed herein. In FIG. 2, x-y rotational capabilities of a laser light source 203 that is part of the projector 101 are indicated by arrows 201 and 202, and respectively represent angular motions of a laser in the x-direction (having angle “β”) and in the y-direction (having angle “α”). In one embodiment, the controller 103 may control the x-y rotational motion of the laser light source 203 based on, for example, scanning instructions.

As depicted in FIG. 2, the laser light source 203 may point scan the surface of an object 204 by projecting light spots along one-dimensional (1D) horizontal scanning lines, two of which S_{R} 205 and S_{R+1} 206 are identified by dotted lines in FIG. 2. The curvature of the surface of the object 204 causes the light spots 207-210 to form the scanning line S_{R} 205 in FIG. 2. For ease and for clarity, the light spots forming the scan line S_{R+1} 206 are not identified using reference indicators. The laser 203 may scan the object 204 along scanning rows S_{R}, S_{R+1}, S_{R+2}, and so on, one spot at a time in, for example, a left-to-right direction.

The values of R, R+1, and so on may also refer to particular rows of pixels in a 2D pixel array 211 of the camera 102, and these values are known. For example, in the 2D pixel array 211 in FIG. 2, the pixel row R is identified using reference numeral 212 and the row R+1 is identified using reference numeral 213. It should be understood that rows R and R+1 of the pixel array 211 have been selected from the plurality of rows of pixels for illustrative purpose only.

The plane containing the rows of pixels in the 2D pixel array 211 may be called the image plane, whereas the plane containing the scanning lines, such as the lines S_{R} and S_{R+1}, may be called the scanning plane. In the embodiment of FIG. 2, the image plane and the scanning plane are oriented using epipolar geometry such that each row of pixels R, R+1, and so on in the 2D pixel array 211 forms an epipolar line of the corresponding scanning line S_{R}, S_{R+1}, and so on. A row R of pixels may be considered epipolar to a corresponding scanning line S_{R} if a projection of an illuminated spot (in the scanning line S_{R}) onto the image plane may form a distinct spot along a line that is the row R itself. For example, in FIG. 2, the arrow 214 depicts the illumination of the light spot 208 by the laser light source 203; whereas the arrow 215 depicts that the light spot 208 is being imaged or projected along the row R 212 of the pixel array 211 by a focusing lens 216. Although not indicated in FIG. 2, it should be understood that all of the light spots 207-210 will be imaged by corresponding pixels in the row R of the pixel array 211. Thus, in one embodiment, the physical arrangement, such as the position and orientation, of the laser 203 and the pixel array 211 may be such that illuminated light spots in a scanning line on the surface of the object 204 may be captured or detected by pixels in a corresponding row in the pixel array 211—that row of pixels thus forms an epipolar line of the scanning line.

The pixels in the 2D pixel array 211 may be arranged in rows and columns. An illuminated light spot may be referenced by the corresponding row and column in the pixel array 211. For example, in FIG. 2, the light spot 208 in the scanning line S_{R} is designated as X_{R,i} to indicate that the spot 208 may be imaged by row R and column i (Cᵢ) in the pixel array 211. The column Cᵢ is indicated by dotted line 217. Other illuminated spots may be similarly identified. It should be noted that it may be possible that light reflected from two or more lights spots may be received by a single pixel in a row, or, alternatively, light reflected from a single light spot may be received by more than one pixel in a row of pixels. Time stamps may also be used for identifying light spots.

In FIG. 2, arrow 218 represents the depth or distance Z (along the z-axis) of the light spot 208 from the x-axis along the front of the camera 102, such as the x-axis shown in FIG. 1. In FIG. 2, the x-axis is indicated by 219, which may be visualized as being contained in a vertical plane that also contains the projection optics (not indicated) of the projector 101 and the collection optics (not indicated) of the camera 102. For ease of explanation of the triangulation method, however, in FIG. 2 the laser source 203 instead of the projection optics being depicted in the x-axis 201. Using a triangulation-based approach, the value of Z may be determined using the following equation:

$$Z = \frac{hd}{q - h tan θ} . \qquad ( 1 )$$

In Eq. (1), the parameter h is the distance (along the z-axis) between the collection optics (not indicated) and the image sensor 211 (which is assumed to be in a vertical plane behind the collection optics); the parameter d is the offset distance between the light source 203 and the collection optics (represented by lens 216) associated with the camera 102; the parameter q is the offset distance between the collection optics of the camera 102 and a pixel that detects the corresponding light spot (in the example of FIG. 2, the detecting/imaging pixel i is represented by column Cᵢ associated with the light spot X_{R,i} 208); and the parameter θ is the scan angle or beam angle of the light source for the light spot under consideration (in the example of FIG. 2, the light spot 208). Alternatively, the parameter q may also be considered as the offset of the light spot within the field of view of the pixel array 211. The parameters in Eq. (1) are also indicated in FIG. 2. Based on the physical configuration of the imaging system 100, the values for the parameters on the right side of Eq. (1) may be predetermined.

It may be seen from Eq. (1) that only the parameters θ and q are variable for a given point scan. The parameters h and d are essentially fixed due to the physical geometry of the imaging system 100. Because the row R 212 is an epipolar line of the scanning line S_{R}, the depth difference or depth profile of the object 204 may be reflected by the image shift in the horizontal direction, as represented by the values of the parameter q for different lights spots being imaged. Thus, from the known value of the scan angle θ and the corresponding location of the imaged light spot (as represented by the parameter q), the distance Z to the light spot may be determined using the triangulation of Eq. (1). It should be noted triangulation for distance measurements is described in the relevant literature including, for example, the U.S. Patent Application Publication No. 2011/0102763 A1 to Brown et al. in which the disclosure related to triangulation-based distance measurement is incorporated herein by reference in its entirety.

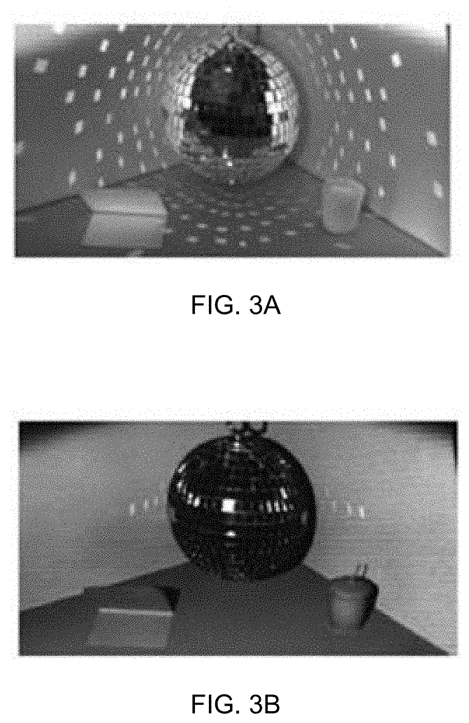

High ambient-light conditions may saturate the pixels of the sensor for short-range objects, while also significantly reducing signal-to-noise ratio (SNR) of longer-range objects. An epipolar, or point-scan, technique may be used to reduce adverse effects caused by high ambient-light conditions when generating estimated depth information. For example, FIG. 3A is a scene of an illuminated mirrored disco ball that has been imaged by a camera using a non-epipolar-imaging technique. The imaged scene in FIG. 3A includes a number of multipath reflections that have been reflected off of the disco ball. Multipath reflection may introduce errors in a 3D depth measurement.

In contrast to FIG. 3A, FIG. 3B is the same scene of the illuminated mirror disco ball that has been imaged using an epipolar-imaging technique. Significantly fewer lights spots that have been reflected off of the disco ball are observable in the image of FIG. 3B than in FIG. 3A because the epipolar-imaging technique rejects multipath reflections. Moreover, distance-related disparity will only be sensed on a sensor epipolar line.

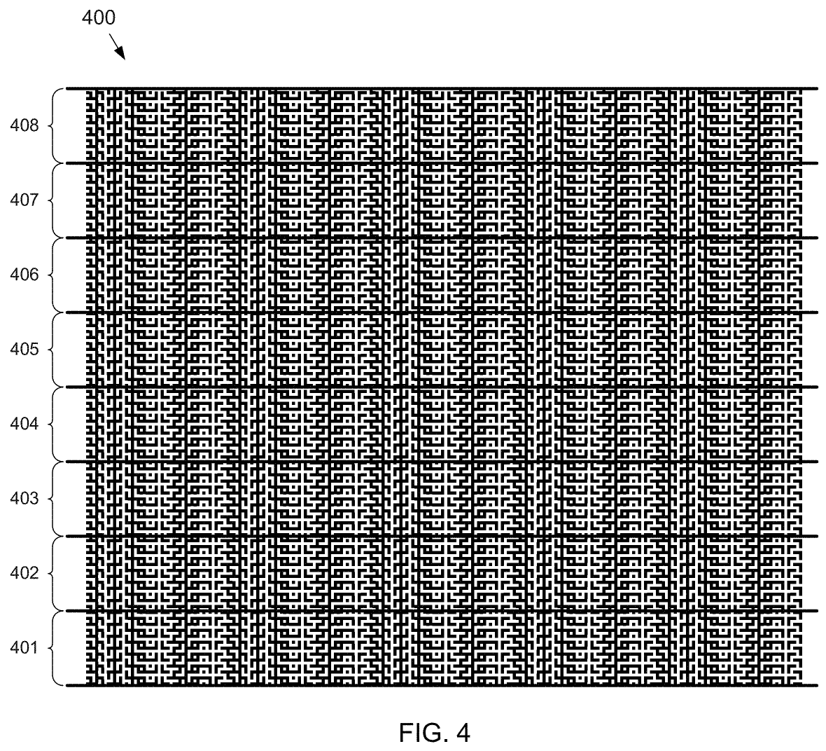

Referring back to FIG. 1, the controller 103 of the structured-light imaging system 100 may control the projector 101 and the camera 102 to image slices of a scene in an epipolar manner. For example, FIG. 4 depicts an example reference light pattern 400 that has been divided into slices 401-408 that may be projected on to a scene slice-by-slice according to the subject matter disclosed herein. Although the example reference light pattern 400 has been divided into eight slices in FIG. 4, it should be understood that any number of slices may be used for scanning a scene.

Each slice 401-408 of the reference light pattern 400 may be selectively projected by the projector 101 in an epipolar manner using a relatively high peak optical power and with relatively short-duration pulses. In one embodiment, the peak optical power may be about 4 W with a pulse duration of about 0.2 μs. The camera 102 may be synchronized with the projector 101 and may include a fast readout circuit with a low-bit analog-to-digital converter (ADC).

Objects in a scanned slice that are at a relatively short range will be detected in the output of the camera 102, usually in one scan. After an object has been detected, the optical power of the projector 101 may be more efficiently used by redirecting pulses towards regions in a scanned slice in which an object has not yet been detected. In one embodiment, the optical power of the projector 101 may be directed to repeatedly scan a selected number of times regions of a slice in which no short range objects have been detected. Any objects in the regions of a slice in which optical power has been redirected may be detected based on accumulating or binning reflected photons. Regions that are repeatedly scanned may be in any order.

The sequence that slices of a scene may be scanned may be in any order, including random a random order. Moreover, although slices are depicted in FIG. 4 as having a generally horizontal rectangular shape, slices may alternatively have a generally vertical rectangular shape if the camera and the projector/scanner have a vertical displacement. As yet another alternative, instead of using slices, regions of a scene having any closed shape may be selectively scanned.

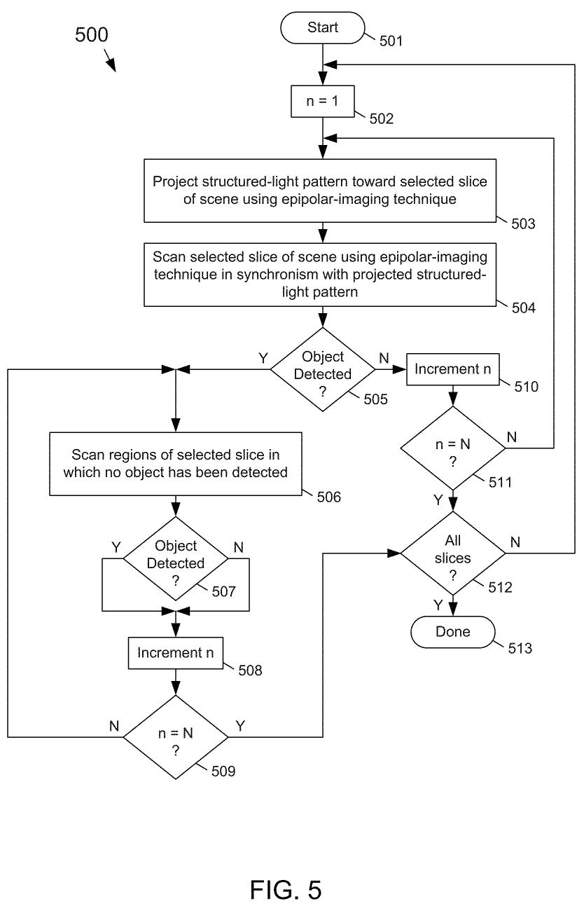

FIG. 5 depicts an example flow diagram of a method 500 of using a structured-light camera system to selectively project/scan a scene in a slice-by-slice manner according to the subject matter disclosed herein. The method starts at 501. At 502, an index n is initialized. At 503, a structured-light pattern is projected toward a selected slice of a scene using an epipolar-imaging technique. The projector may be controlled to use a relatively high optical power with relatively short pulses. At 504, the scene is scanned using an epipolar-imaging technique in synchronism with the projected pulses in 503. At 505, it is determined whether an object has been detected within the selected slice. Short-range objects may be detected based on the number of photoelectrons that have been received.

If, at 505, an object is detected, flow continues to 506, where regions of the selected slice in which no object has been detected are scanned using an epipolar-imaging technique. That is, the optical power of the projector is directed to regions of the selected slice in which no object has been detected, and the regions are scanned using an epipolar-imaging technique. Repeated projection of the structure-light pattern may be directed only to regions in which no object detected have been detected and may reveal objects at longer ranges. At 507, it is determined whether an object has been detected in any of the regions being scanned. Flow continues to 508, where the index n is incremented. At 509, it is determined whether the index n equals a predetermined number N, such as 8. Other predetermined values for the predetermined number N may be used.

If, at 509, it is determined that the index n does not equal the predetermined number N, flow returns to 506 where regions of the selected slice in which no object have been detected are scanned in an epipolar-imaging manner. If, at 509, the index n equals the predetermined number N, flow continues to 512 where it is determined whether all slices have been scanned. If so, flow continues to 513 where the method ends. If, at 512, all slices have not been scanned, flow returns to 502.

If, at 505, it is determined that no objects have been detected, flow continues to 510 where the index n is incremented and then tested at 511. If, at 511, the index does equal the predetermined number N, flow returns to 503. If, at 511, the index equals the predetermined number N, flow continues to 512 where it is determined whether all slices have been scanned.

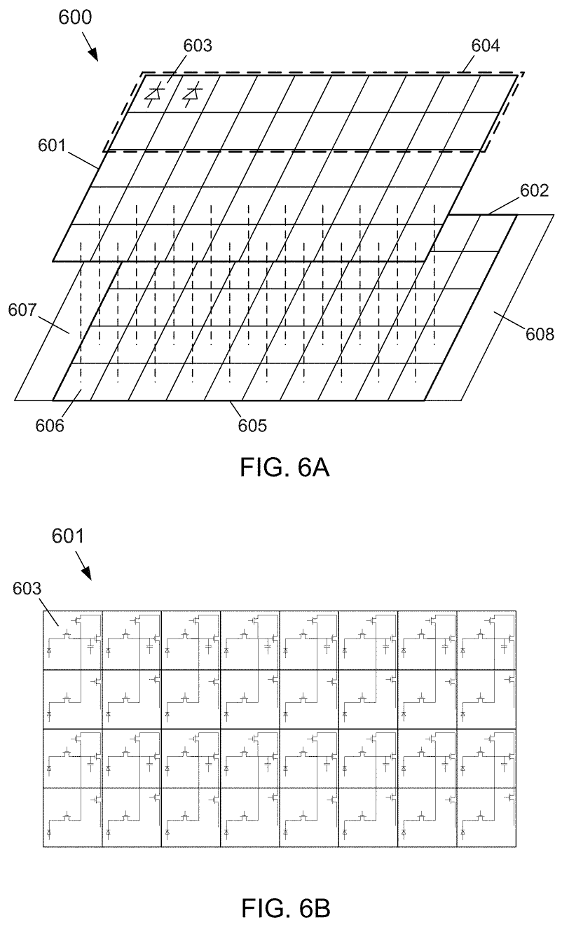

FIG. 6A depicts an example stacked architecture 600 that may be used for a sensor in the camera 102 according to the subject matter disclosed herein. The stacked architecture 600 may include a pixel array 601 in a top layer, and peripheral and ADC circuitry 602 in a bottom layer. The pixel array may include a plurality of pixels 603, of which only one pixel 603 has been indicated in FIG. 6A. The pixel array may be arranged to include a plurality of global shutter arrays 604, of which only one global shutter array 604 has been indicated. In one embodiment, each global shutter array 604 may correspond to one epipolar projection/scan line. Other sizes are possible for a global shutter array. In an alternative embodiment, the pixel array may be arranged to include a shutter array that may be operated in a rolling shutter mode. The bottom layer 602 may include a low-bit ADC array 605 that includes a plurality of ADCs 606, of which only one ADC 606 has been indicated. In one embodiment, each ADC 606 may be coupled to a corresponding pixel 603 through a fast readout circuit (as indicated by the dashed lines), and may have a resolution of four bits or less. The bottom layer 602 may also include a row driver array 607 and a bias and other circuitry 608.

FIG. 6B depicts an example embodiment of the pixels 603 of the pixel array 601 according to the subject matter disclosed herein. In one embodiment, a pixel 603 may have a well-known four transistor (4T) structure that includes a QIS photodetector. In another example embodiment, the pixels 603 may have a shared structure. Each pixel 603 includes a photodiode that may have a full well capacity of less than about 200e−, and may have a conversion gain that may be greater than about 500 CtV/e−. A small pixel pitch of about 1 μm may also be used.

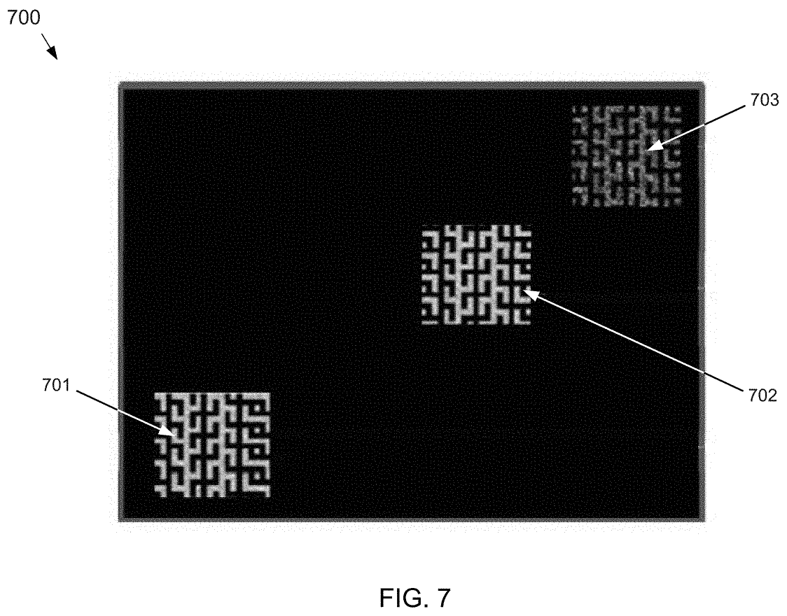

FIG. 7 depicts an example portion 700 of an output of a detected slice of a scene according to the subject matter disclosed herein. In one embodiment, the slice may include 480 scan lines in which the detected outputs from the pixels may be binned in 4×4 bins. Regions of the example portion 700 that are indicated as black represent pixels that have received only ambient light photons. Pixels indicated as white are pixels that have received ambient light photons plus reflected photons of the reference light pattern. For example, a region 701 of the example portion 700 may include a detected object that, for this example, has a range of 0.3 m. The black pixel receives less than one election, while the white pixel receives 30 electrons. A region 702 may include a detected object that has a range of 1 m. With ten scans, the black pixel receives total 0.2 electrons and the white pixel receives 30 electrons. A region 703 may include a detected object that has a range of 4 m. With ten scans and 4×4 binning, the black pixel receives 3.2 electrons and the white pixel receives 40 electrons.

Objects that are closest to the camera reflect more photons that are detected by the pixel array, while objects further away reflect fewer photons that are detected by the pixel array. The difference in the number of detected photons based on the range of an object is depicted in FIG. 7 as the intensity of the white portion of the detected reference light pattern. Once an object is detected, the projected light from, for example, the projector 101 in FIG. 1, may be repeatedly redirected to other areas in which fewer or no reflected photons have been detected until an object is detected. Binning may be used to collect enough reflected photons to detect an object. For example, region 702 may detect an object with only one scan, whereas ten scans may be needed to detect objects in regions 703 and 704.

The reflectivity of objects may be estimated based on a difference between black pixels and white pixels. That is, regions of the example portion 700 that are indicated as black represent pixels that have received only ambient light photons, whereas pixels indicated as white are pixels that have received ambient light photons plus reflected photons of the reference light pattern. The difference between the two represents the number of active electrons. The theoretical number of active electrons is related to the distance of an object, which may be obtained using triangulation-based approach of Eq. (1). By determining a ratio of the received and the theoretical numbers of active electrons, the reflectivity of the object captured by a particular pixel may be determined.

As will be recognized by those skilled in the art, the innovative concepts described herein can be modified and varied over a wide range of applications. Accordingly, the scope of claimed subject matter should not be limited to any of the specific exemplary teachings discussed above, but is instead defined by the following claims.

What is claimed is:

1. A structured-light imaging system, comprising:
a projector that projects a structured-light pattern onto a selected slice of a scene comprising one or more objects, the selected slice of the scene comprising a first predetermined size in a first direction and a second predetermined size in a second direction that is substantially orthogonal to the first direction;
an image sensor that scans the selected slice of the scene and generates an output corresponding to a region of the selected slice, the image sensor and the projector being synchronized in an epipolar manner; and
a controller coupled to the image sensor that detects whether an object is located within the scanned region and that controls the projector to project the structured-light pattern a first plurality of times away from the scanned region towards other regions of the selected slice of the scene if an object has been detected in the scanned region.

2. The structured-light imaging system of claim 1, wherein the structured-light pattern comprises a row of a plurality of sub-patterns extending in the first direction, each sub-pattern being adjacent to at least one other sub-pattern, each sub-pattern being different from each other sub-pattern, each sub-pattern comprising a first predetermined number of regions in a sub-row and second predetermined number of regions in a sub-column in which the first predetermined number and the second predetermined number is an integer, each region comprising substantially a same size, each sub-row extending in the first direction and each sub-column extending in a second direction that is substantially orthogonal to the first direction.

3. The structured-light imaging system of claim 2, wherein the plurality of sub-patterns comprises 48 sub-patterns,
wherein the first predetermined number and the second predetermined number are equal to each other, and
wherein a region corresponds to a dot of the structured-light pattern.

4. The structured-light imaging system of claim 2, wherein the first plurality of times comprises ten times.

5. The structured-light imaging system of claim 1, wherein the controller further determines a reflectivity of a detected object based on an intensity difference between black pixels and white pixels in the scanned region.

6. The structured-light imaging system of claim 1, wherein the first predetermined size of the selected slice in the first direction is greater than the second predetermined size of the selected slice in the second direction,
wherein the controller further controls the projector to project the structured-light pattern toward a first predetermined number of slices in a selected order, and
wherein the image sensor scans the first predetermined number of slices in the selected order.

7. The structured-light imaging system of claim 6, wherein the selected order is a random order.

8. A structured-light imaging system, comprising:
a projector that projects a structured-light pattern onto a selected slice of a scene comprising one or more objects, the selected slice of the scene comprising a first predetermined size in a first direction and a second predetermined size in a second direction that is substantially orthogonal to the first direction, the first predetermined size of the selected slice in the first direction being greater than the second predetermined size of the selected slice in the second direction;
an image sensor that scans the selected slice of the scene and generates an output corresponding to a region of the selected slice, the image sensor and the projector being synchronized in an epipolar manner; and
a controller coupled to the image sensor that detects whether an object is located within the scanned region and that controls the projector to project the structured-light pattern a first plurality of times away from the scanned region towards other regions of the selected slice of the scene if an object has been detected in the scanned region.

9. The structured-light image system of claim 8, wherein the controller further controls the projector to project the structured-light pattern toward a first predetermined number of slices in a selected order,
wherein the image sensor scans the first predetermined number of slices in the selected order, and
wherein the selected order is a random order.

10. The structured-light imaging system of claim 9, wherein the structured-light pattern comprises a row of a plurality of sub-patterns extending in the first direction, each sub-pattern being adjacent to at least one other sub-pattern, each sub-pattern being different from each other sub-pattern, each sub-pattern comprising a first predetermined number of regions in a sub-row and second predetermined number of regions in a sub-column in which the first predetermined number and the second predetermined number is an integer, each region comprising substantially a same size, each sub-row extending in the first direction and each sub-column extending in a second direction that is substantially orthogonal to the first direction.

11. The structured-light imaging system of claim 10, wherein the plurality of sub-patterns comprises 48 sub-patterns, and
wherein the first predetermined number and the second predetermined number are equal to each other.

12. The structured-light imaging system of claim 11, wherein the first plurality of times comprises ten times.

13. The structured-light imaging system of claim 10, wherein the controller further determines a reflectivity of a detected object based on an intensity difference between black pixels and white pixels in the scanned region.

14. A method for a structured-light imaging system to scan a scene, the method comprising:
projecting from a projector a structured-light pattern onto a selected slice of a scene comprising one or more objects, the selected slice of the scene comprising a first predetermined size in a first direction and a second predetermined size in a second direction that is substantially orthogonal to the first direction;
scanning the selected slice of the scene using an image sensor, the image sensor and the projector being synchronized in an epipolar manner;
generating an output corresponding to a region of the selected slice;
detecting whether an object is located within the scanned region; and
controlling the projector using a controller to project the structured-light pattern a first plurality of times away from the scanned region towards other regions of the selected slice of the scene if an object has been detected in the scanned region.

15. The method of claim 14, wherein the structured-light pattern comprises a row of a plurality of sub-patterns extending in the first direction, each sub-pattern being adjacent to at least one other sub-pattern, each sub-pattern being different from each other sub-pattern, each sub-pattern comprising a first predetermined number of regions in a sub-row and second predetermined number of regions in a sub-column in which the first predetermined number and the second predetermined number is an integer, each region comprising substantially a same size, each sub-row extending in the first direction and each sub-column extending in a second direction that is substantially orthogonal to the first direction.

16. The method of claim 15, wherein the plurality of sub-patterns comprises 48 sub-patterns,
wherein the first predetermined number and the second predetermined number are equal to each other, and
wherein the first predetermined number of times comprises ten times.

17. The method of claim 14, wherein the first predetermined size of the selected slice in the first direction is greater than the second predetermined size of the selected slice in the second direction,
the method further comprising:
controlling the projector to further project the structured-light pattern toward a first predetermined number of slices in a selected order, and
scanning the first predetermined number of slices in the selected order, and
wherein the selected order is a random order.

18. The method of claim 14, wherein the image sensor includes a plurality of global shutter arrays in which a global shutter array corresponds to an epipolar scan line, and
the method further comprising:
operating the image sensor in one of a random shutter mode and a rolling shutter mode.

19. The method of claim 14, further comprising projecting the structured-light pattern the first plurality of times away from the scanned region to detect an object that is farther away than the object detected in the scanned region.

20. The method of claim 14, further comprising determining at the controller a reflectivity of the object detected in the scanned region based on an intensity difference between black pixels and white pixels in the scanned region.
